(19) United States
(12) Patent Application Publication
(10) Pub. No.: US 2014/0127994 A1
(43) Pub. Date: May 8, 2014

(54) POLICY-BASED RESOURCE ACCESS VIA NFC

(71) Applicant: MICROSOFT CORPORATION, Redmond, WA (US)

(72) Inventors: Edmund Nightingale, Redmond, WA (US); Paul Barham, San Francisco, CA (US); Brian LaMacchia, Seattle, WA (US)

(73) Assignee: Microsoft Corporation, Redmond, WA (US)

(21) Appl. No.: 13/670,484

(22) Filed: Nov. 7, 2012

(51) Int. Cl. H04W 12/08; H04B 5/00

(52) U.S. Cl. CPC H04W 12/08; H04B 5/00
USPC 455/41.1

(57) ABSTRACT

A resource access system is described herein that solves problems associated with visitor access to resources at a location by using NFC or bump as a fast authentication process to grant persistent visitor rights to a resource, subject to policy conditions such as maintaining the link. The system provides a facility for granting access to NFC/bump-enabled visitors visiting a new location by assigning a persistent link with associated policy. The system provides for a bump/NFC-enabled device to authenticate with a proximate local resource and grant rights to a visiting device. This action proves that the device to be granted rights is physically present at the location of the resource, and does not involve any exchange of codes or user information with the user. Thus, the resource access system provides simplified setup of visitor access to location resources using NFC and similar short-field communication technologies.

### BACKGROUND

When a visitor comes to a new location with a Wi-Fi network or other resources (e.g., printers), a common method of authentication is to provide credentials to a web-based access system including a username and password, or alternatively entering a one-time or limited-use access code. Hotels, conference centers, coffee shops, and other locations often have requirements to ensure that those using publicly provided resources are those that are supposed to. For example, a coffee shop may want to provide Wi-Fi access to its customers but not to everyone passing on the street. Various methods have been used provide such authentication. For example, the location may set a new password each day and give the password to those authorized to use the resources. The location may provide a web page that everyone can access through which a user enters the password to be able to access any other pages.

Near field communication (NFC) is a type of network connection that involves the close proximity of a transmitting chip and a corresponding receiver. In some cases, the transmitter is powered by a magnetic field provided by the receiver that induces a current in a loop of wire, while in other cases both sides of the communication are powered. For example, smartphones may include NFC hardware such that two smartphones can be brought close together to initiate NFC-based communication or a smartphone may be brought close to some other receiver to initiate NFC-based communication with the receiver. Unlike Bluetooth and other short-range networking technologies, NFC has a relatively simple setup process without complex pairing or other steps. Thus, two devices that are previously unknown to each other can be brought together to establish a connection without any prior setup.

Once an NFC connection has been made, the connection can be used to transmit various types of data. NFC has been used in contactless payment scenarios to allow a smartphone or other device to be used in lieu of a traditional credit card with a swipe-able magnetic strip. In some cases, plastic credit cards themselves have included both a magnetic strip and an NFC-based chip so that either swiping or contactless payment can be used to identify the card and provide a credit card number or other identifying information.

Existing procedures for granting visitors of a location access to the location's computing resources are slow and involve disclosure of information, such as access codes, to the visitor or gathering user information from the visitor. This complicates the use of location resources by the visitor and may not directly map to those users that are intended to have access to the resources. For example, a person at a neighboring location may obtain the access code or other information and be able to use the resources even though he or she is not intended to by the owner or operator of the resources.

### SUMMARY

A resource access system is described herein that solves problems associated with visitor access to resources at a location by using NFC or bump (i.e., bring two devices into close enough contact to communicate with each other via a radio-based or other protocol) as a fast authentication process to grant persistent visitor rights to a resource, subject to policy conditions such as maintaining the link or a time-based lease. The system provides a facility for granting access to NFC/bump-enabled visitors visiting a new location by associating a device with a policy via physical contact (e.g., a bump). The system provides for a bump/NFC-enabled device to authenticate with a proximate local resource and grant rights to a visiting device. This action proves that the device to be granted rights is physically present at a specific location, and does not involve any exchange of codes or user information with the user. The rights granted then allow access to the granting device or an additional resource. A device is authenticated by proximity or by contact (i.e., bump or NFC conditions). In this way, the NFC or similar hardware acts as a simplified means of establishing entitlement to access to some set of resources at the location. NFC may also be used to establish which type of rights a user is requesting. Thus, the resource access system provides simplified setup of visitor access to location resources using NFC and similar short-field communication technologies.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the resource access system, in one embodiment.

FIG. 2 is a flow diagram that illustrates processing of the resource access system to establish a link between a visiting device and one or more location-based resources, in one embodiment.

FIG. 3 is a flow diagram that illustrates processing of the resource access system to receive policy configuration information, in one embodiment.

FIG. 4 is a block diagram that illustrates a setup of the resource access system at a visited location that provides guest access to resources via bump enabled technology, in one embodiment.

### DETAILED DESCRIPTION

A resource access system is described herein that solves problems associated with visitor access to resources at a location by using NFC or bump as a fast authentication process to grant persistent visitor rights to a resource, subject to policy conditions such as maintaining a Wi-Fi link or other action (e.g., in the case of resources other than a Wi-Fi link). Management of the link and termination of a link are not addressed by typical Wi-Fi scenarios, and the same is common with other types of resources. The system may also provide access to resources other than a Wi-Fi link, such as bumping to receive a Wi-Fi password, or access to a hotel mini bar whenever a hotel guest's smartphone is present in the room and connected to hotel Wi-Fi. Alternatively or additionally, the system may transfer something more secure, such as issuing a certificate credential to be used for an 802.1X-style authentication, which could later be revoked. The system provides a facility for granting access to NFC/bump-enabled visitors visiting a new location by assigning a persistent link (e.g., a deep link) with associated policy. The system provides for a bump/NFC-enabled device to authenticate with a proximate local resource and grant rights to a visiting device. For example, a printer at a coffee shop or other business center may have NFC hardware that allows a visitor with a smartphone having NFC hardware to print using the printer after the user brings the phone into range of the printer's NFC hardware or other NFC hardware at the location (e.g., a bump location at the entrance or next to a register). This action proves that the device to be granted rights is physically present at the location, and does not involve any exchange of codes or user information with the user. The rights granted then allow access to the granting device or an additional resource, such as a Wi-Fi network in the owner's home. For example, home users may provide a wireless network for guests that can be accessed after bringing a device requesting access into range of NFC or similar short-field communication hardware. By this action, the user of the device demonstrates that he or she is physically in the home, and thus is entitled to access the guest Wi-Fi network.

One method of implementing guest Wi-Fi access is to keep two Wi-Fi areas, one for the local home network to which visitors have no access, and the other for guest access to the visitor side of the network. The network can be dual-homed, or may provision access through a proxy on the Wi-Fi manager. A device is authenticated by proximity or by contact (i.e., bump or NFC conditions). For example, a visitor may obtain secure Wi-Fi access rights on the owner's home wireless network by tapping their phone against the owner's router. Access may also be provided by proxying Wi-Fi access through the access point and/or Wi-Fi manager based on policy for the guest access. In this way, the NFC or similar hardware acts as a simplified means of establishing entitlement to access to some set of resources at the location. NFC may also be used to establish which type of rights a user is requesting. For example, there may be multiple NFC zones that the visitor can bump his or her device to request access to a Wi-Fi network, a printer, a television, a music collection, or some other resource or various levels of access to each of these resources. Thus, the resource access system provides simplified setup of visitor access to location resources using NFC and similar short-field communication technologies. In another example, bumping provides a key that is used to access the home network, which expires after a predefined period (e.g., 24 hours).

The resource access system enables easy setup of several types of functionality that are complicated today. First, the system enables the leveraging of an NFC/bump event by a visitor device with a private network to provision a policy association that provides guest or visitor access to resources and the network. The event satisfies a policy that categorizes and enables the provisioning. Second, the system enables monitoring and applying policy to the link such that if any condition is not satisfied, the link is terminated based on a violation of rules. Policy rules can include temporal, physical, and situational factors such as time, place, distance from network, and expirations of invitations. Third, the system enables dividing visitor access to a network into a guest service set identification (SSID) or other identifier and private home SSID Wi-Fi configuration such that provisioned bump devices are granted limited access through the guest network after policy is satisfied, while private home devices continue to receive full access via the home network or other policy. Various extensions are described herein that can enable further functionality.

The resource access system is a system for granting access to visitors visiting a new location to resources at the location by assigning a persistent or deep link with associated management policy. The system provides for a bump/NFC-enabled device to authenticate with a proximate local resource and grant rights to a visiting device. The rights then allow access to the granting device or an additional resource, such as a Wi-Fi network at the location. For example, a visitor may obtain secure Wi-Fi access rights at an owner's home wireless network by tapping their phone against the owner's router. Similarly, customers in a coffee shop could obtain access by tapping a centrally located device. Rights persist after the initial contact or proximity based on various policy conditions defined by the owner.

The infrastructure around the deep link is capable of providing access to resources through a portable device, and other aspects of the policy around the link, such as temporal constraints on how long the link is active, limits on proximity (e.g., how far from the location the visitor can go and maintain the rights), and the scope of rights granted. For example, a visitor may obtain a bump-based persistent link at the router, spend some time in a home, and then lose the link when the location of the device exceeds the property boundary or when a specified period has passed (or some combination of these and other conditions). The system can have a notion of visitors who are “invited” to the link as a condition of establishing the link. For example, a policy rule may be provided to the system in advance of a visitor attempting access. The system can include a rule-based policy system capable of determining when to establish a deep link based on bump/NFC authentication satisfying provisioning conditions, and the policy and conditions of the newly established deep link based on policy determined by the granting device with conditions for terminating the link later.

When a device is brought near another device (which can be a dedicated Wi-Fi manager, any machine on a private network, or some arbitrary ‘proxy’ device and so forth), the system provides a rules-based policy system where conditions are to be met before the device can be granted any type of access to local resources. NFC/bump communication allows the devices to guarantee proximity or physical contact in addition to requiring one or more additional conditions not provided by NFC alone. After making the determination that the conditions of the rules are satisfied, the deep link is established with rights based on policy associated with the rules. For example, when a portable device with NFC support is brought near a secure printer, the secure printer can request a close proximity of the device for authentication (or a bump with the printer), a particular time window under which printing may be accomplished by the user, and items on the printer associated with that user. In the printer scenario, the deep link policy monitoring may request that the user maintain presence near the printer or other NFC device associated with the printer, else the policy association is broken and secure printing stops. Likewise, the printing may be required to complete within a certain time window, or the link is broken. Finally, the link policy may require that the link be terminated after printing of the last page is completed, even if all other conditions are still met.

The resource access system may provide or receive a policy that combines temporal and spatial qualities, or other combinations of policies to gain and maintain access to resources. For example, the system may provide access to hotel resources (e.g., guest Wi-Fi, a mini bar, movies, and so forth) for as long as a hotel guest is present in his or her hotel room and bumped his or her smartphone at the hotel registration desk upon check-in. Similar scenarios include authentication for purchasing goods within a limited time window, joining teleconference sessions by device presence near a teleconference portal and a requirement that the user be an invitee (the additional condition), and temporary key storage. Another example is a monitor and keyboard station where the user is a known member of an active directory service, and proximity is maintained to the keyboard and monitor, and the user is physically detected such as by a webcam or microphone (as specified by link policy). Those skilled in the art will recognize numerous other scenarios to which a policy system based on NFC and additional conditions can be applied to remove complexity and to provide additional assurances not guaranteed by traditional methods of granting access.

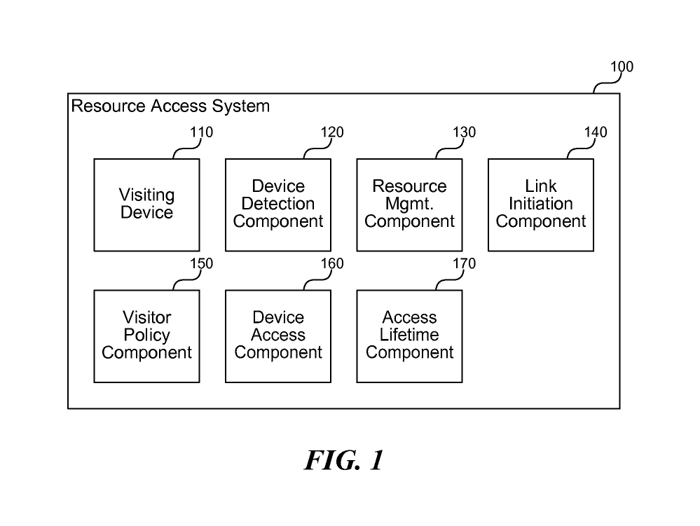

FIG. 1 is a block diagram that illustrates components of the resource access system, in one embodiment. The system 100 includes a visiting device 110, a device detection component 120, a resource management component 130, a link initiation component 140, a visitor policy component 150, a device access component 160, and an access lifetime component 170. Each of these components is described in further detail herein. Although described separately, those skilled in the art will recognize that various conceptual components described herein may be implemented together in the same software library or hardware component. For example, components 120 to 170 may be part of a trust provider, while component 110 is outside of the trust boundary.

The visiting device 110 is a computing device that includes bump enabled technology (e.g., near-field communication (NFC), Bluetooth, or Wi-Fi) that can be detected by a receiving device. The visiting device 110 may be a smartphone, MP3 player, tablet computer, laptop, or other portable computing device that includes an NFC chip or similar hardware for leveraging the system 100 described herein. The visiting device may be a device carried by a user visiting a location that has resources that the visitor can use. The visiting device 110 may request access to resources for the use of the visiting device 110 itself, or for other devices (e.g., a separate laptop) carried by the visiting user. The user may carry several devices that communicate using similar or separate communication technologies as are used by the resource access system, such as a smartphone that acts as a personal Wi-Fi hotspot for a laptop or tablet computer.

The device detection component 120 is a physical device associated with the location being visited that includes bump enabled technology for detecting the visiting device 110. The device detection component 120 may be part of a device similar to the visiting device 110, such as another smartphone, may be part of resources to which access can be provided, such as a printer or router with NFC hardware, or may be separate peripherals or computing devices entirely. The device detection component 120 detects the presence or proximity of devices such as visiting device 110, and informs the resource management component 130 so that policy conditions can be verified to determine whether to grant or deny access to location resources to the visiting device 110. In some cases, a text label or other indication may inform a visiting user that bringing the visiting device 110 into proximity of the device detection component 120 will enable particular functionality or resource access. A particular location may include multiple instances of the device detection component 120 that serve multiple visiting users, multiple available resources at the location, or for other purposes such as differentiating multiple types of access that a visiting user can request (e.g., tap one location on a printer to request color printing and another to request black and white printing).

The resource management component 130 catalogs one or more available resources at the location being visited and manages access of visiting devices to the cataloged resources. Resources may include any type of computing device, peripheral, or other device that a visiting user may be granted access to through the system 100, such as printers, Wi-Fi networks, games, lights, stereo systems, speakers, projectors, and so forth. The resource management component 130 may provide an administrative interface, such as a web-based configuration application, a mobile application, programmatic interface, or other interface through which an administrator (such as the owner of the location) can inform the resource management component 130 of particular resources available at the location. The resource management component 130 may also use automated facilities to identify and determine available resources, such as through a network broadcast, universal plug and play (UPnP) request, or similar communication.

The link initiation component 140 initiates a link between the visiting device 110 and the one or more available resources at the location being visited. The link may include establishing a Wi-Fi connection, Bluetooth connection, or other communication following initial communication through the bump enabled technology (e.g., NFC hardware or similar) of the visiting device 110 and device detection component 120. The NFC-based communication may identify the visiting device 110 (e.g., by device identifier, credentials, key-pair, MAC address, internet protocol (IP) address, or other identifier), so that when link initiation occurs by another protocol, the secondary protocol is aware of the device and its permitted level of access to the resource(s). Either the visiting device 110 or the resource may initiate the link following an exchange of information via NFC.

The visitor policy component 150 manages one or more policy rules that define conditions under which a visiting device can access resources at the location being visited. The rules may include policy information related to both what access to resources can be granted as well as when that access can be taken away. For example, access to a Wi-Fi network may be loosely granted to anyone that can prove his or her presence (through an NFC bump or similar proof) at the location, but may be limited in time (e.g., 30 minutes), location (e.g., valid as long as the user is within 100 feet of the location), or other constraints that may terminate or limit access to the resource once that access has been granted. The visitor policy component 150 may provide a user interface or programmatic interface through which an administrator can specify policy rules applicable to a particular location. The visitor policy component 150 manages the storage and enforcement of any received or default rules.

The device access component 160 provides access to the visiting device 110 to a particular resource in response to a determination by the visitor policy component that the visiting device 110 has satisfied one or more conditions for such access. The device access component 160 may inform particular resources, such as a printer or Wi-Fi network, to accept usage requests from the visiting device 110. For example, the device access component may add the visiting device's MAC address to a list of allowable MAC addresses that can connect to a Wi-Fi router for access to the Internet. The device access component 160 is responsible for communication between the resource management component 130 and the visitor policy component 150 to carry out the policy for accessing resources.

The access lifetime component 170 enforces policy rules related to termination of access from the visiting device 110 to one or more resources. Access to resources is typically not granted indefinitely or without some renewal procedure. For example, a business owner that provides Wi-Fi access may only want to provide public Internet access to customers for a limited duration, or may want customers to renew access periodically. To do this, the business owner may specify policy rules that require visitors to tap the visiting device 110 against the device detection component 120 periodically (e.g., every hour), or after a purchase at the merchant's business, to maintain or restore access to the resources. The access lifetime component 170 may carry out actions for terminating access (e.g., removing a visiting device MAC address from a list of allowed addresses) as well as actions for notifying and informing a visiting user that access to a resource is about to be terminated (e.g., via a push notification, email, or other notification).

The computing device on which the resource access system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

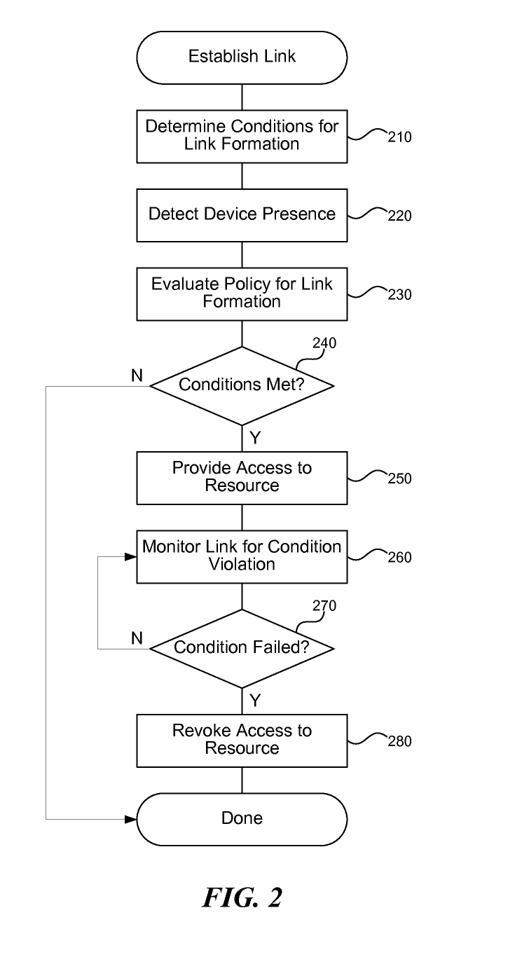

FIG. 2 is a flow diagram that illustrates processing of the resource access system to establish a link between a visiting device and one or more location-based resources, in one embodiment. Beginning in block 210, the system determines initial conditions for formation of a link between a visiting device and one or more resources associated with a location being visited. The initial conditions may include invitations, an open router, the time of day, or any other policy settings provided by a predefined policy. The policy may include rules about who can access resources and/or conditions under which access will be granted (e.g., proven presence at the location).

Continuing in block 220, the system detects the presence of the visiting device. The system may detect presence based on a bump against a bump sensor or near-field communication (NFC) hardware coming within proximity of an NFC receiver to allow NFC communication to determine that the visiting device is present. Detecting the presence of the visiting device may include determining which of multiple available NFC receivers the visiting device interacted with via proximity.

Continuing in block 230, the system evaluates a policy for formation of a link between the one or more resources and the visiting device based on the detected presence of the visiting device. The conditions may specify a particular NFC receiver that the visiting device must contact to access a particular resource, a range of types of the visiting device that are allowed to access a particular resource, that the visiting device has not previously exceeded any particular time or other limits on further use of a resource, and so forth.

Continuing in decision block 240, if the system determines that the policy for formation of the link is satisfied, then the system continues at block 250, else the system denies access to the one or more resources and completes. To determine whether the policy is satisfied, the system reviews policy and conditions to apply to the formation and persistence of the link (and possible transfer to a Guest or limited-rights SSID, for example).

Continuing in block 250, the system provides access from the visiting device to the one or more resources. The system forms a link with the visiting device and creates a persistent association in a link manager capable of monitoring conditions (in one case, on a guest SSID). The access policy may specify particular resources the visiting device can access, such as a Wi-Fi router, printer, or other resource, as well as any conditions or limitations of the access (e.g., printing of a limited number of pages or transferring a limiting amount of data).

Continuing in block 260, the system monitors the established link for violation of any condition that would lead to termination of the link. The system may monitor the guest link and evaluate policy around the link for a violation of conditions for maintaining the link (e.g., proximity, time, access attempts, physical location, and so on). For example, access to a Wi-Fi resource may be time limited to an hour or other duration, while access to a printer may be limited by number of pages, proximity to the printer, and so forth. In some cases, the nature of the bump that grants access also determines the type or conditions of access. For example, the system may specify that a user bump once for each 20 minutes of requested Wi-Fi access, and thus if the user bumps three times the system may grant that visiting device 60 minutes of Wi-Fi access.

Continuing in decision block 270, if the system detects that a condition failed, then the system continues at block 280, else the system loops to block 260 to continue monitoring the link conditions. A condition may fail because of an action of the visiting device or a user of the device (e.g., exceeding a limited grant of access or moving out of the area for proximity-based conditions), because of expiration of a granted access lifetime, or for any other reason specified by the resource owner through one or more policy rules. For example, a business that closes at a particular time may expire access grants at the time of closing, while a homeowner that provides Wi-Fi to guests may allow access for a limited duration (e.g., 24 hours) from the initial request. Upon failure of a condition, the system may allow the user to renew the access by repeating the steps specified here again. For example, if the user again bumps his or her device against the appropriate NFC receiver, then the system may again grant the user and/or visiting device additional access (e.g., by extending the access lifetime or renewing other policy conditions).

Continuing in block 280, the system revokes access of the visiting device to the one or more resources based on failure of a policy condition. Revoking access may include the system communicating with particular resources to drop existing connections or usage and to prevent further usage of the resource by the device. For example, in the case of a Wi-Fi connection, the system may maintain a list of MAC addresses or other identifiers that are allowed to use the Wi-Fi network, such that access can be revoked by removing any particular device from the list. After block 280, these steps conclude.

Following are a list of just some of the many scenarios that the resource access system can enable using steps like those just described. In some instances, NFC establishes an initial setup communication between a router and an administrator-privileged machine to build permanent access. The bump occurs between these two devices. For guest access, there are more parties involved, and potentially more levels in the stack. For example, a guest laptop could bump any other computer on the network (as opposed to the router) to negotiate access so that a third party is involved rather than just the router. As another example, the set of resources provided to the visitor could be dependent on which machine the visitor bumps (e.g., bumping the file server provides access to certain file shares, bumping the printer provides access to the printer device, and so on).

In some embodiments, the resource access system includes a user interface or other configuration process for authorizing a bump and the access created through bumping. For example, the system may request that the owner or manager of a location explicitly enable bump-based access and specify the type and scope of access provided to one or more resources at the location. Different locations may prefer different policies, or there may be varying policies per resource at a particular location. Sometimes, something can be bumped at any time, e.g., anyone who is a guest in a house can bump the router to get access. Other times, the owner may explicitly allow a visitor to bump (or activate the device for a single bump). For example, a merchant might only allow a customer to gain access via bump after the customer buys something to prevent free access.

For wireless networks, a guest wireless local area network (WLAN) may be secured and encrypted (rather than open) and a guest laptop can be provided an SSID and key for the network via NFC (subject to the deep link described herein). A conventional (open) guest WLAN can use MAC address filtering to control access to guest devices, and the MAC address filter can be updated by NFC bumping a trusted machine on the home network, which reconfigures the router. For a business premises, having a “key of the day” is useful for not having someone who patronizes a location one day continue to use the resources on other days on which they do not make a purchase. For access points that support virtual Wi-Fi, then a new SSID can be instantiated on the fly (i.e., a new virtual access point) and the SSID and key provided to guests via NFC. In this way, the guest network can be transient and can automatically be deleted at the end of the day (e.g., to make keys harder to crack by brute force). The amount of access time or other quantity of resource usage can be configured by the number of bumps (like a parking meter). The system may also make it so that different guests cannot see each other's traffic and may apply traffic shaping to stop guests taking too much bandwidth.

The system may provide access to different sets of location resources (e.g., file server, printer on a guest WLAN or other network) depending on which machine or NFC receiver the visitor bumps against. The system can work with a MICROSOFT™ WINDOWS™ HomeGroup that allows authentication against network shares, media servers, and printers on the home network to provide access to the HomeGroup via bump enabled technology. The HomeGroup on the home network can have an additional visitor or public level of access to resources. The system may also leverage a plurality of HomeGroups—one for trusted users and another for visitors. The visitor can be provided a new transient HomeGroup that expires after a specified time (as above), or that has other restrictions.

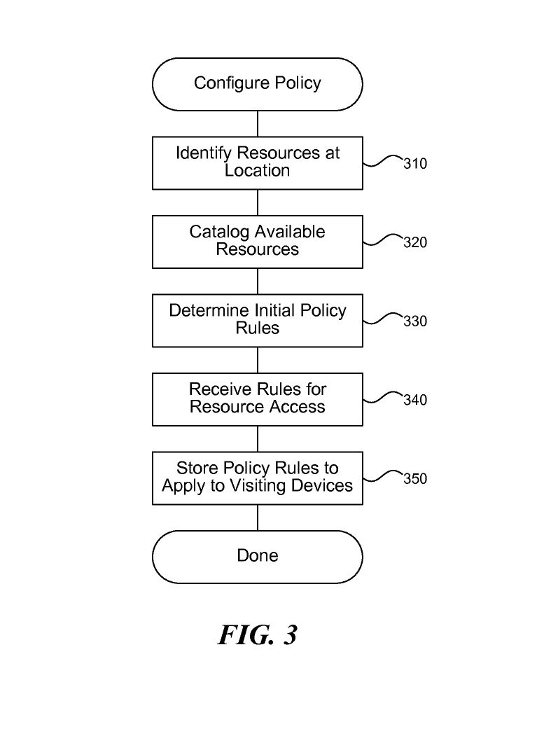

FIG. 3 is a flow diagram that illustrates processing of the resource access system to receive policy configuration information, in one embodiment. Beginning in block 310, the system identifies one or more resources available for guest access at a particular location. For example, the resources may include networks, printers, file shares, home electronics, or any other types of resources at the location. The system may identify resources automatically, such as through UPnP or other device enumeration protocols, or may manually receive information describing resources from an administrative user or owner, such as through a configuration user interface.

Continuing in block 320, the system catalogs the available resources and stores information describing the available resources in a resource data store. The data store may include one or more files, file systems, hard drives, databases, cloud-based storage services, or other facilities for storing data. The system may track an identity of each resource as well as other information, such as a resource type, default policy rules for accessing the resource, any customization of policy or restrictions on use or lifetime of use defined by the resource owner, and so on.

Continuing in block 330, the system determines initial policy rules to apply to each resource wherein at least one rule specifies initiation of access to a resource using near-field communication (NFC) in combination with other policy rules. The policy rules may specify who can access the resources, conditions or actions to be performed to gain access to the resources, a lifetime or limited duration of any granted access, conditions for maintaining access, and so forth. For example, for a detected Wi-Fi router the system may allow guest access for any guest that initiates an NFC-based connection with the router and may allow such access for as long as the guest is within a defined proximity of the router (which the system may measure by Wi-Fi signal strength, triangulation between routers, or other measure).

Continuing in block 340, the system receives customized policy rules for accessing the identified resources. The customized rules are specified by an administrator or resource owner and define the conditions for initial and continued access to the identified resources. The rules may identify particular NFC or similar receivers and may define what effect accessing each such receiver has to grant a visiting user access to identified resources. For example, bumping one NFC receiver may grant Wi-Fi access rights, while bumping another NFC receiver may grant printing rights. The system may provide a user interface or programmatic interface through which administrators of the system can access the system and provide customized rules and other configuration information. For example, the system may provide a web-based user interface or a mobile application that administrators can access from the network to configure the system.

Continuing in block 350, the system stores the received policy rules and applies the rules to devices visiting the location that request access to the identified resources by using NFC proximity between a visiting device and an NFC receiver associated with the location. The system stores the policy rules in a policy rule data store and accesses the rules when a visiting device initiates a request for access, such as by bumping the visiting device or another device associated with the visiting device in proximity of the NFC receiver (or one of multiple NFC receivers). After block 350, these steps conclude.

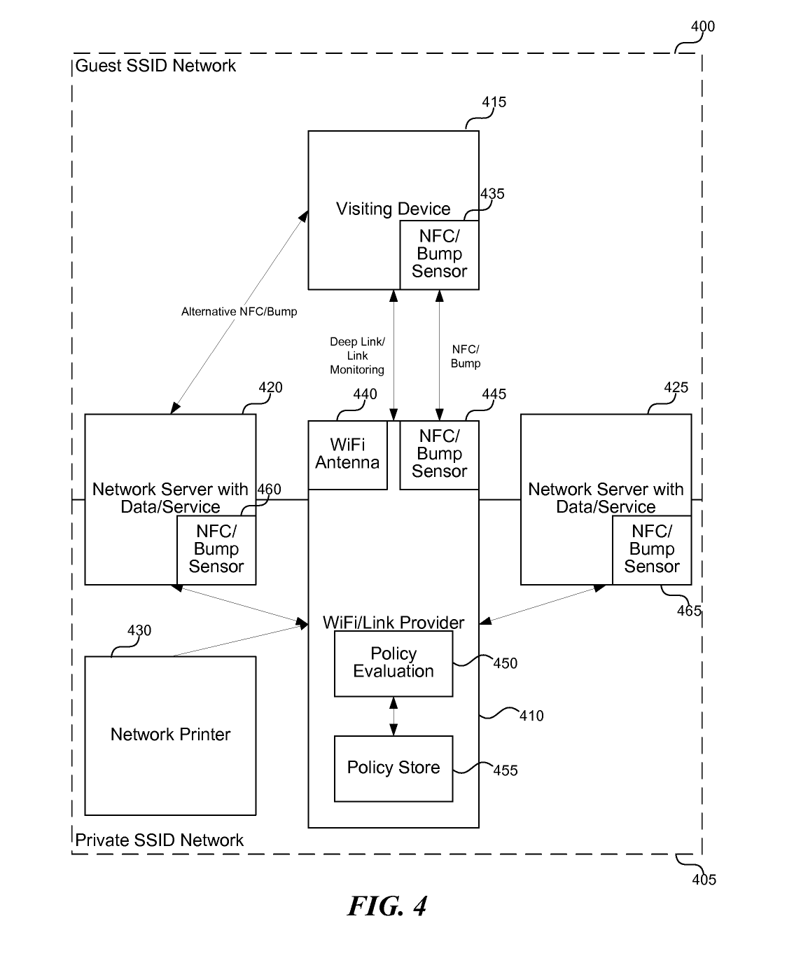

FIG. 4 is a block diagram that illustrates a setup of the resource access system at a visited location that provides guest access to resources via bump enabled technology, in one embodiment. The location includes a guest network 400 and a private network 405. The two networks include various resources, some only available via one network and some shared across both networks, such as network server 420, network server 425, and network printer 430 (shown in one network but could be shared also). The networks also include an associated Wi-Fi/link provider 410 that includes a Wi-Fi antenna 440 (or multiple antennas), a policy evaluation component 450, and a policy store 455. The policy store 455 includes policy information describing conditions under which visitors can access various resources, which resources are bump enabled, and so on. A visiting device 415 arrives at the location and includes a bump enabled sensor 435. Various devices at the location may also include bump enabled hardware, such as bump sensor 460 associated with network server 420, bump sensor 445 associated with the link provider 410, and bump sensor 425 associated with network server 425. By bringing the visiting device 415 into contact with each of these bump sensors, a user of the visiting device 415 can gain access to various resources at the location in accordance with the policy. The policy store 455 may also include conditions for maintaining access to the resources once granted. The link provider 410 performs monitoring of the access of the visiting device 415 to enforce these conditions.

From the foregoing, it will be appreciated that specific embodiments of the resource access system have been described herein for purposes of illustration, but that various modifications may be made without deviating from the spirit and scope of the invention. Accordingly, the invention is not limited except as by the appended claims.

I/We claim:

1. A computer-implemented method to establish a link between a visiting device and one or more location-based resources, the method comprising:
determining initial conditions for formation of a link between a visiting device and one or more resources associated with a location being visited and determining whether or not the formation of a link is permitted by a location policy;
detecting the presence of the visiting device;
evaluating a policy for formation of a link between the one or more resources and the visiting device based on the detected presence of the visiting device;
upon determining that the policy for formation of the link is satisfied, providing access from the visiting device to the one or more resources;
monitoring the established link for violation of any policy condition that would lead to termination of the link; and
upon detecting that a condition failed, revoking access of the visiting device to the one or more resources based on failure of a policy condition,
wherein the preceding steps are performed by at least one processor.

2. The method of claim 1 wherein detecting the presence comprises detecting presence based on a bump against a bump sensor at the location.

3. The method of claim 1 wherein detecting the presence comprises detecting presence based on near-field communication (NFC) hardware of the visiting device coming within proximity of an NFC receiver at the location to allow NFC communication to determine that the visiting device is present.

4. The method of claim 3 wherein detecting the presence comprises determining which of multiple available NFC receivers the visiting device interacted with via proximity.

5. The method of claim 1 wherein evaluating the policy comprises identifying a type of the visiting device based on information communicated during detecting the presence of the device and determining that a bumping is explicitly permitted by a third party.

6. The method of claim 1 wherein evaluating the policy comprises evaluating at least one policy condition that specifies which of multiple presence detection devices a visiting device must interact with to access a particular resource.

7. The method of claim 1 wherein evaluating the policy comprises evaluating whether the visiting device has previously exceeded a limit on further use of a resource at the location.

8. The method of claim 1 wherein providing access comprises forming a link with the visiting device and creating a persistent association in a link manager capable of monitoring conditions.

9. The method of claim 1 wherein providing access comprises providing access to a guest Wi-Fi network under limited conditions based on the policy.

10. The method of claim 1 wherein monitoring the established link comprises evaluating policy around the link for a violation of conditions for maintaining the link, wherein the conditions include a combination of temporal and spatial conditions.

11. The method of claim 1 wherein detecting that a condition failed comprises detecting an action of the visiting device or a user of the device.

12. The method of claim 1 wherein detecting that a condition failed comprises detecting expiration of a granted access lifetime.

13. The method of claim 1 wherein revoking access comprises communicating with particular resources to drop existing connections or usage and to prevent further usage of the resource by the visiting device.

14. A computer system for providing policy-based resource access via bump enabled technology, the system comprising:
a processor and memory configured to execute software instructions embodied within the following components;
a visiting device comprising a computing device that includes bump enabled technology that can be detected by a receiving device;
a device detection component associated with a location being visited that includes bump enabled technology for detecting the visiting device;
a resource management component that catalogs one or more available resources at the location being visited and manages access of visiting devices to the cataloged resources;
a link initiation component that initiates a link between the visiting device and the one or more available resources at the location being visited;
a visitor policy component that manages one or more policy rules that define conditions under which a visiting device can access resources at the location being visited;
a device access component that provides access from the visiting device to a particular resource in response to a determination by the visitor policy component that the visiting device has satisfied one or more conditions for such access; and
an access lifetime component that enforces policy rules related to termination of access from the visiting device to one or more resources based on one or more policy conditions.

15. The system of claim 14 wherein the visiting device is a mobile computing device carried by a user visiting the location and wherein the bump enabled technology includes near field communication (NFC) hardware of the mobile computing device.

16. The system of claim 14 wherein the device detection component is associated with a particular resource to which the visiting device can request access by making contact with the device detection component.

17. The system of claim 14 wherein the device detection component detects the presence or proximity of devices such as the visiting device and informs the resource management component so that policy conditions can be verified to determine whether to grant or deny access to location resources to the visiting device.

18. The system of claim 14 wherein the resource management component automatically identifies available resources at the location.

19. The system of claim 14 wherein the policy rules of the visitor policy component specify one or more temporal or geographical conditions related to access of the visiting device to the one or more resources.

20. A computer-readable storage medium comprising instructions for controlling a computer system to receive policy configuration information for access from a visiting device to resources at a visited location, wherein the instructions, upon execution, cause a processor to perform actions comprising:
identifying one or more resources available for guest access at a particular location;
cataloguing the available resources and storing information describing the available resources in a resource data store;
determining initial policy rules to apply to each resource wherein at least one rule specifies initiation of access to a resource using near-field communication (NFC) in combination with other policy rules;
receiving customized policy rules for accessing the identified resources; and
storing the received policy rules and applying the rules to devices visiting the location that request access to the identified resources by using NFC proximity between a visiting device and an NFC receiver associated with the location.
